(19) United States
(12) Patent Application Publication
(10) Pub. No.: US 2010/0131119 A1
(43) Pub. Date: May 27, 2010

(54) COMMUNICATION SYSTEM BETWEEN CONTROL UNITS FOR IRRIGATION DEVICES

(76) Inventors: Andrea Brundisini, Pordenone (IT); Franco Milan, Caneva (IT)

Correspondence Address: JACOBSON HOLMAN PLLC, 400 SEVENTH STREET N.W., SUITE 600, WASHINGTON, DC, 20004, US

(21) Appl. No.: 12/452,806

(22) PCT Filed: Jul. 18, 2008
(86) PCT No.: PCT/EP2008/059434

§ 371 Date: Jan. 22, 2010

(30) Foreign Application Priority Data
Jul. 23, 2007 (IT) MI 2007A 001476

(51) Int. Cl. G06F 1/26

(52) U.S. Cl. 700/296

(57) ABSTRACT

A communication system between a main control unit (100) for irrigation devices and at least one secondary control unit (A1 . . . An) for irrigation devices, specifically for battery powered control units, is described; each control unit (100, A1 . . . An) includes a module (10, 20) for the transmission of data to the other control unit and for the reception of data from the other control unit. The main control unit (100) and the at least one secondary control unit (A1 . . . An) include means (4) adapted to allow the power supply of said data transmission and reception modules only during the time periods (T, T1 . . . Tn) required for the exchange of data between the main control unit (100) and the at least one secondary control unit (A1 . . . An).

The present invention relates to a communication system between control units for irrigation devices.

The control of irrigation devices by means of control units placed at positions which are easily accessible from the irrigation area is known in the state of the art. The control units may be programmed by a user to set the irrigation time periods on various days of the month and during each month of the year. The setting of the irrigation time periods may be modified depending on the environmental conditions or on other events.

Each control unit may control up to a given number of irrigation devices; the use of a greater number of irrigation devices and a certain number of control units is therefore required for very broad irrigation areas.

In some cases, the irrigation systems include a main control unit and secondary control units and communication devices between the main control unit and the secondary control units are provided for the transmission of data regarding the irrigation time periods and the state of the control units. In the case in which the control units are battery powered, the communication between the control units may require an excessive consumption of energy to the detriment of the battery life.

In view of the state of the art, the object of the present invention is to provide a communication system between control units for irrigation devices which allows the exchange of data between control units, specifically for battery powered control units.

According to the present invention, such an object is achieved by means of a communication system between a main control unit for irrigation devices and at least one secondary control unit for irrigation devices, specifically for battery powered control units, each control unit including a module for the transmission of data to the other control unit and for the reception of data from the other control unit, characterised in that said main control unit and said at least one secondary control unit include means adapted to allow the power supply of said data transmission and reception modules only during the time periods required for the exchange of data between the main control unit and at least one secondary control unit.

The features of the present invention will become more apparent from the following detailed description of a practical embodiment thereof, shown by way of non-limitative example in the accompanying drawings, in which:

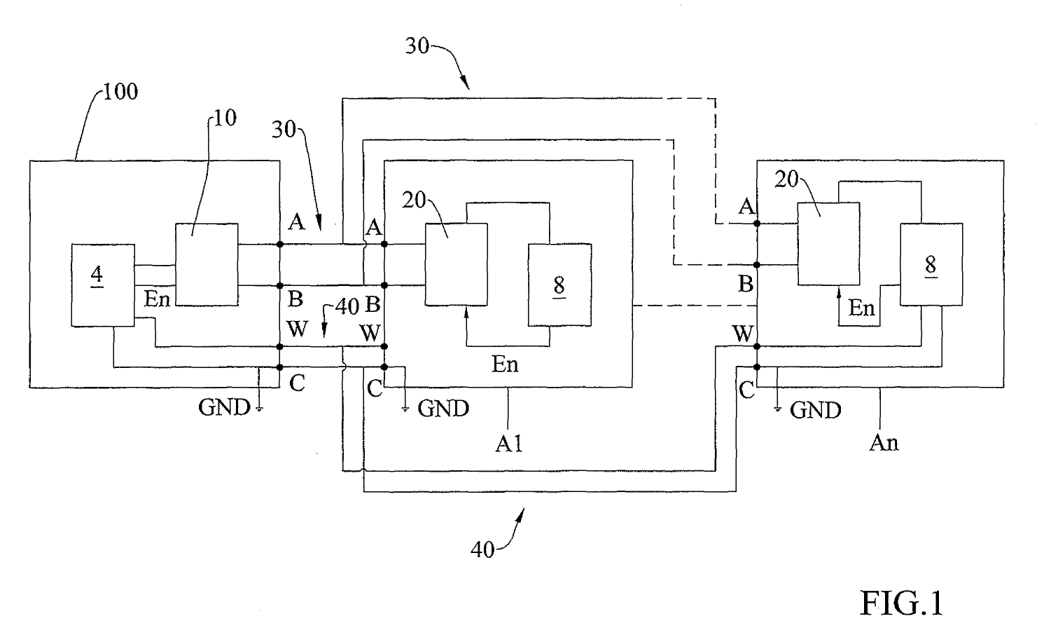

FIG. 1 is a diagram of a communication system between irrigation device control units according to a first embodiment of the invention;

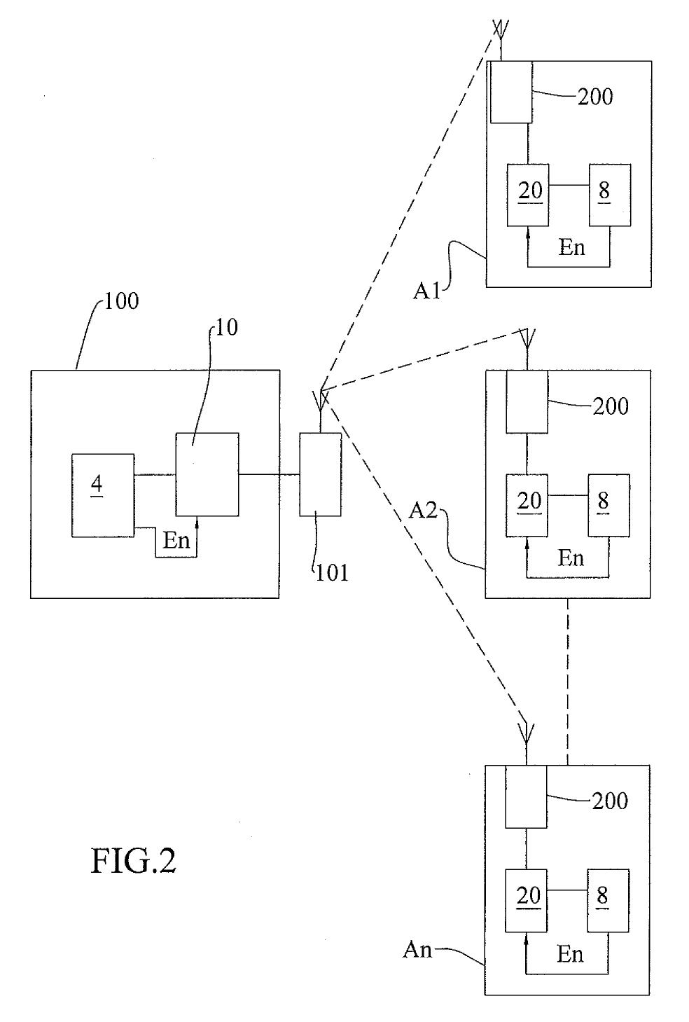

FIG. 2 is a diagram of a communication system between irrigation device control units according to a second embodiment of the invention.

FIG. 1 shows a diagram of a communication system between irrigation device control units according to a first embodiment of the invention. The diagram shows a main control unit or a main module 100 and at least one secondary control unit or expansion module A1 . . . An, although a plurality of secondary control units A1 . . . An is preferable; the control units are battery powered and therefore have a limited power supply in the course of time. The control unit 100 includes a module 10 for the transmission and the reception of data and each of the control units A1 . . . An includes a module 20 for the transmission and the reception of data.

In FIG. 1, the modules 10 and 20 are provided with two terminals A and B for the connection by means of a connection cable 30, for instance a standard RS-485 wire, and a terminal C for the connection to ground GND.

The main control unit 100 and each secondary control unit A1 . . . An are provided with a terminal W for another connection by means of a cable 40. The connection by means of the cable 40 allows to minimize energy consumption during the communication between the control units; the cable 40 is a two-way wake-up line.

Both the control unit 100 and each of the control units A1 . . . An include respective data processing devices 4, 8 provided with a memory on which an application software is installed and runs. The devices 4 and 8 provide for the control of the modules 10 and 20.

When the main control unit 100 must communicate with one or more control units A1 . . . An, the device 4 operates to enable the line 40 in order to send the information regarding the request for communication between the main control unit 100 and the secondary control units A1 . . . An which are addressed by means of the cable 30 and it then operates to enable the device 10 for the transmission of data by means of a signal En.

The devices 8 of all of the control units A1 . . . An which receive the request for information from the control unit 100 operate to enable the modules 20 for the reception of data by means of an enabling signal En and the communication starts. At the end of the communication, the wake-up line is disabled again by the device 4 of the main control unit 100 and the system returns to a low energy state. Therefore, the modules 10 and 20 are enabled only for the time T required for the exchange of data between the main control unit 100 and the secondary control units A1 . . . An which have received the request for information.

It may also occur that one of the secondary control units A1 . . . An must communicate with the main control unit 100; in this case the device 8 of the control unit A1 . . . An which requests the communication operates to enable the line 40 to send the information regarding the request for communication with the main control unit 100 by means of the cable 30 and then operates to enable its own device 20 by means of a signal En for the transmission of data. The device 4 of the main control unit 100 operates to enable the module 10 for the reception of data by means of an enabling signal En and the communication starts. At the end of the communication the wake-up line is disabled and the system returns to the low energy state. Therefore, the modules 10 and 20 are enabled only for the time T required for the exchange of data between the main control unit 100 and the secondary control unit A1 . . . An which has requested the communication.

The communication between the main control unit 100 and the control units A1 . . . An may be requested by the control unit 100 when there is a variation in the state of the irrigation devices, when the single control units need to be initialized, when the operation of the single control units needs to be set or the firmware of the single control units needs to be updated.

The communication between the main control unit 100 and the control units A1 . . . An may be requested by one of the control units A1 . . . An when a variation of the state of the sensors results in the need to inform the control unit 100 so that it operates accordingly.

FIG. 2 shows a diagram of a communication system between irrigation device control units according to a second embodiment of the invention. Said communication system differs from the system in FIG. 1 in that it communicates in a different manner, i.e. not through a connection cable but instead by means of the data transmission by radio frequency over the air.

The main control unit or main module 100 and the plurality of secondary control units A1 . . . An are always of the battery powered type. The main control unit 100 always includes the module 10 for the transmission and the reception of data and each one of the control units A1 . . . An includes the module 20 for the transmission and the reception of data; the modules 10 and 20 are always controlled in order to transmit or receive data from the processing devices 4 and 8. The modules 10 and 20 are generally provided in this case with two radiofrequency transceivers 101 and 200, preferably a 433 MHz radio frequency, with a corresponding antenna for the transmission and reception of data over the air; the transceiver 101 is generally arranged outside the body of the control unit 100 which includes the module 10 and the processing device 4, although it may also be arranged within the body of the control unit 100. The transceivers 101 and 200 may also allow a data transmission with a Bluetooth or Wireless Lan system.

The main control unit 100 and the secondary control units A1 . . . An are reciprocally synchronized by sending a global command by the control unit 100 to all of the control units A1 . . . An at predetermined time intervals Tp, for instance corresponding to one minute. In this manner, the devices 8 of the control units A1 . . . An hold the transceiver 200 always disabled although the module 200 is activated every minute, synchronously with all of the control units A1 . . . An, by means of a signal En to verify the presence of data to be transferred.

The communication between the main control unit 100 and the control units A1 . . . An may be requested by the control unit 1 when there is a variation in the state of the irrigation devices, when the single control units need to be initialized and synchronized, when the operation of the single control units needs to be set or the firmware of the single control units needs to be updated.

The communication between the main control unit 100 and the control units A1 . . . An may be requested by one of the control units A1 . . . An when a variation of the state of the sensors results in the need to inform the control unit 100 of the variation.

The state of the irrigation devices may be sent by the secondary control units A1 . . . An to the main control unit 100 each minute when the synchronism occurs. Such a communication occurs over a time period T1 . . . Tn assigned to each secondary control unit and is related to its identification number.

In this manner, when the state of the sensor needs to be sent and only then, does a secondary control unit A1 . . . An also enable its transmitter module 200. As the transmission power is higher than that required when receiving, this technique also allows to considerably limit energy consumption.

For instance, a minute may be subdivided into 20 3-second time windows, each one of which has a duration of 3 seconds.

During the first time window T0=3s, the state of the valves and a command informing all of the secondary control units A1 . . . A19 on how to behave during the remaining sequential time windows T1 . . . T19 are sent by the main control unit.

Normally, after the first time window, the main control unit 100 starts to receive and the secondary control units A1 . . . An one at a time transmit only during the time windows T1 . . . Tn assigned thereto. The commands sent by the main control unit 100 during the first time window T0 could request the secondary control units A1 . . . An not to transmit for the following minute or to receive again during the time window assigned thereto for possible operation parameter update functions. Another command could be for instance to reprogram the firmware of all of the secondary control units A1 . . . An. The possibility to receive commands during the first time window allows for other possibilities or future requirements.

A communication system between the control units of the irrigation devices may be provided according to a variant of the above said embodiments, the main control unit 100 of the communication system being provided both with a module 10 having terminals A and B for the cable connection with some control units, such as in FIG. 1, and with a radiofrequency transceiver 101 for the communication over the air with other control units, such as in FIG. 2.

For the system in FIG. 1, in the case in which there are no energy consumption issues, for instance when the control units 100 and A1 . . . An are power supplied by a network or have recharged batteries, the number of cables may be reduced by eliminating the line 40 and short-circuiting it towards the ground GND on each control unit.

1. A communication system between a main control unit for irrigation devices and at least one secondary control unit for irrigation devices, specifically for battery powered control units, each control unit including a module for the transmission of data to the other control unit and for the reception of data from the other control unit, said main control unit and said at least one secondary control unit including means adapted to allow the power supply of said data transmission and reception modules only during the time periods required for the exchange of data between the main control unit and at least one secondary control unit, wherein it includes a cable connected between the module for the reception and transmission of data of the main control unit and the module for the reception and transmission of data of the at least one secondary control unit and a further cable connected between the main control unit and the at least one secondary control unit, said main control unit or said at least one secondary control unit being adapted to enable said further cable by sending thereon the information regarding the request for data communication between said main control unit and said at least one secondary control unit and being adapted to disable said further cable once the data communication is finished.

2. The system according to claim 1, wherein it includes a plurality of secondary control units, the control units of said plurality of control units being connected to said cable and to said further cable, said main control unit being adapted to enable said further cable by sending thereon the information regarding the request for data communication between said main control unit and some secondary control units of said plurality of secondary control units and being adapted to disable said further cable once the data communication is finished.

3. The system according to claim 1, wherein said main control unit and said at least one secondary control unit are adapted to activate the respective modules for the reception and transmission of data once said further cable has been enabled.

4. The system according to claim 1, wherein said main control unit is provided with a radiofrequency transceiver for the communication over the air with other control units.

5. A communication system between a main control unit for irrigation devices and at least one secondary control unit for irrigation devices, specifically for battery powered control units, each control unit including a module for the transmission of data to the other control unit and for the reception of data from the other control unit, said main control unit and said at least one secondary control unit including means adapted to allow the power supply of said data transmission and reception modules only during the time periods required for the exchange of data between the main control unit and at least one secondary control unit, wherein said main control unit and said at least one secondary control unit each includes a transceiver over the air connected to respective modules for the reception and transmission of data between the main control unit and the at least one secondary control unit, said main control unit being adapted to synchronize said at least one secondary control unit by sending a command at predetermined intervals, said at least one secondary control unit being adapted to enable its own transceiver while said command is being sent.

6. The system according to claim 5, wherein it includes a plurality of secondary control units, each of said predetermined intervals including a number of sequential time windows which are equivalent to the number of said secondary control units of the plurality of secondary control units, each of said time windows being assigned to a single secondary control unit so that said secondary control unit enables its own transceiver only during said time window assigned for the data transmission and reception with the main control unit.

7. The system according to claim 5, wherein said main control unit is provided both with a module having terminals for the cable connection with some control unit.

8. The system according to claim 1, wherein the means of said main control unit and of said at least one secondary control unit adapted to allow the power supply of said data transmission and reception modules include a data processing device with a memory on which an application software is installed and runs.
